(19) United States
(12) Patent Application Publication
(10) Pub. No.: US 2014/0380480 A1
(43) Pub. Date: Dec. 25, 2014

(54) METHOD, DEVICE AND SYSTEM FOR IDENTIFYING HARMFUL WEBSITES

(71) Applicant: Tencent Technology (Shenzhen) Company Limited, Shenzhen (CN)

(72) Inventor: Kun TANG, Shenzhen (CN)

(73) Assignee: Tencent Technology (Shenzhen) Company Limited, Shenzhen (CN)

(21) Appl. No.: 14/258,533

(22) Filed: Apr. 22, 2014

Related U.S. Application Data
(63) Continuation of application No. PCT/CN2013/090085, filed on Dec. 20, 2013.

(30) Foreign Application Priority Data
Jun. 25, 2013 (CN) 201310256829.3

(51) Int. Cl. H04L 29/06

(52) U.S. Cl. CPC H04L 63/101; H04L 63/308
USPC 726/24

(57) ABSTRACT

The present disclosure provides a method for identifying harmful websites, which comprises receiving, by a terminal device having a processor, at least one input address of a target website; receiving, by the terminal device, a local blacklist comprising at least an address of at least one harmful website; determining, by the terminal device, whether the input address of the target website matches any address in the local blacklist; if the input address of the target website match one address in the local blacklist, identify the target website as a harmful website; if the input address of the target website does not match any address in the local blacklist, uploading the input address to a security detection server.

### CROSS-REFERENCE TO RELATED APPLICATIONS

This application is a continuation application of PCT Patent Application No. PCT/CN2013/090085, filed on Dec. 20, 2013, which claims priority to a Chinese Patent Application No. 201310256829.3, filed on Jun. 25, 2013, both of which are incorporated by reference in their entireties.

### FIELD OF THE TECHNOLOGY

The present disclosure relates generally to the field of Internet technologies and, more particularly, to a method, device and system for identifying harmful websites.

### BACKGROUND

Harmful websites refer to websites corresponding to web pages attached with malicious programs such as Trojans, viruses, malicious scripts or other forms of computer crimes. Harmful websites may cause a computer system to be infected with computer viruses and result in privacy exposure or data losses.

Currently, methods for identifying harmful websites are usually based on internet gateways. Before forwarding an access request, if the website corresponding to the access request is identified to be a harmful website by a gateway, the gateway will return a security warning prompt page and block the access request.

In the field of mobile devices and wireless communications, a mobile device is usually not connected to a unique gateway device due to their mobility. Thus, one problem associated with current methods for identifying harmful websites for mobile devices is that a mobile device may become unprotected when it switches from one subnet to another because not all the gateways are protected from harmful websites. In other words, conventional methods for identifying harmful websites in mobile devices rely on gateways to which the mobile devices are connected and are thus not very reliable.

### SUMMARY

The present disclosure provides a method for identifying harmful websites that can improve security. A method for identifying harmful websites comprises: receiving, by a terminal device having a processor, at least one input address of a target website; receiving, by the terminal device, a local blacklist comprising at least an address of at least one harmful website; determining, by the terminal device, whether the input address of the target website matches any address in the local blacklist; if the input address of the target website match one address in the local blacklist, identifying the target website as a harmful website; if the input address of the target website does not match any address in the local blacklist, uploading the input address to a security detection server. This method may further comprises receiving teleprocessed information from the security detection server; determining whether the target website is safe based on the teleprocessed information, and if the target website is not safe, identifying the target website as a harmful website; if the target website is safe, acquiring web content of the target website, and loading the web content.

The present disclosure also provides a method for identifying harmful websites, which comprises receiving, from a terminal device, requests to perform a security detection on a target website; performing, by a server device having a processor, a security detection on the target website; generating, by the server device, teleprocessed information based on the security detection results; and returning, by the server device, the teleprocessed information to the terminal device.

Furthermore, the present disclosure provides a device for identifying harmful websites. A device for identifying harmful websites, comprises a processor and a non-transitory storage medium accessible to the processor, the non-transitory storage medium is configured to store the following modules implemented by the processor: a first acquisition module configured to receive at least an input address of a target website; a second acquisition module configured to receive a local blacklist comprising at least one address of at least one harmful website; and a determination module configured to determine whether the input address matches any address in the local blacklist, if the input address matches one address in the local blacklist, identify the target website as a harmful website; and if the input address does not match any address in the local blacklist, uploading the input address to a security detection server; receiving teleprocessed information from the security detection server; determining whether the target website is safe based on the teleprocessed information, and if the target website is not safe, identifying the target website as a harmful website; if the target website is safe, acquiring web content of the target website, and loading the web content.

Further, the present disclosure also provides a system for identifying harmful websites that can improve security. A system for identifying harmful websites, comprising a client terminal and a security detection server, wherein the client terminal is configured to receive at least an input address of a target website, receive a local blacklist comprising at least an address of at least one harmful website, determine whether the address of the target website matches any address in the local blacklist; if the input address matches one address in the local blacklist, identify the target website as a harmful website; if the input address does not match any address in the local blacklist, upload the input address to the security detection server; receive teleprocessed information from the security detection server; determine whether the target website is safe based on the teleprocessed information; and identify the target website as a harmful website if the target website is not safe; the security detection server is configured to receive requests to perform a security detection on the target website, perform a security detection on the target website, generate teleprocessed information based on the detection results, and return the teleprocessed information to the client terminal.

The foregoing methods, device and system for identifying harmful websites perform security detection at a client terminal to determine whether an inputted website is harmful, so that the client terminal does not have to totally rely on the harmful website identification functions of the gateways of various subnets when a carrier switches between different subnets during movement, and thereby improve security.

The foregoing methods, device and system for identifying harmful websites perform detection on an inputted target website both at a local client terminal and on a remote security detection server and thus further reduce the risk of omitting any harmful website, thereby improve security.

### BRIEF DESCRIPTION OF THE DRAWINGS

The accompanying drawings are included to provide a further understanding of the claims and disclosure, are incorporated in, and constitute a part of this specification. Apparently, the accompanying drawings in the following description are only some embodiments of the present disclosure, and persons of ordinary skill in the art may further derive other drawings according to these accompanying drawings without creative efforts. In the drawings.

FIG. 1 is a process flow diagram of a method for identifying harmful websites according to an embodiment of the present disclosure.

FIG. 2 is a process flow diagram of a method for identifying harmful websites according to another embodiment of the present disclosure.

FIG. 3 is a schematic block diagram of a terminal device for identifying harmful websites according to an embodiment of the present disclosure.

FIG. 4 is a schematic block diagram of a terminal device for identifying harmful websites according to another embodiment of the present disclosure.

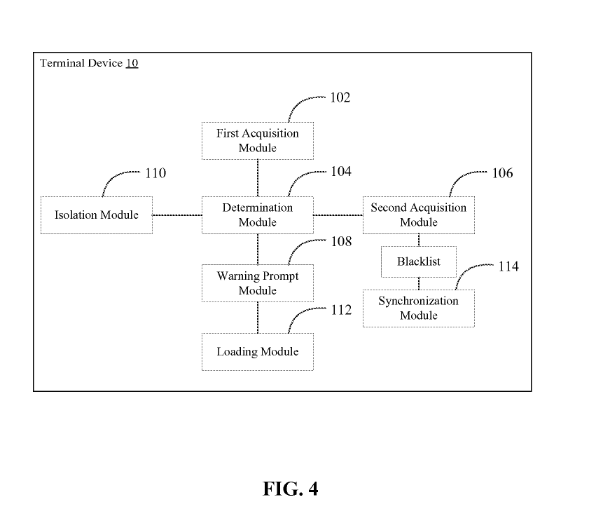

FIG. 5 is a process flow diagram of a method for identifying harmful websites according to another embodiment of the present disclosure.

FIG. 6 is a schematic block diagram of a system for identifying harmful websites according to an embodiment of the present disclosure.

FIG. 7 is a schematic block diagram of a system for identifying harmful websites according to another embodiment of the present disclosure.

### DETAILED DESCRIPTION OF THE EMBODIMENTS

The various embodiments of the present disclosure are further described in details in combination with accompanying drawings and embodiments below. Like numbered elements in the same or different drawings perform equivalent functions. It should be understood that the specific embodiments described here are used only to explain the present disclosure, and are not intended to limit the present disclosure.

Reference throughout this specification to “one embodiment,” “an embodiment,” “example embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an example embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

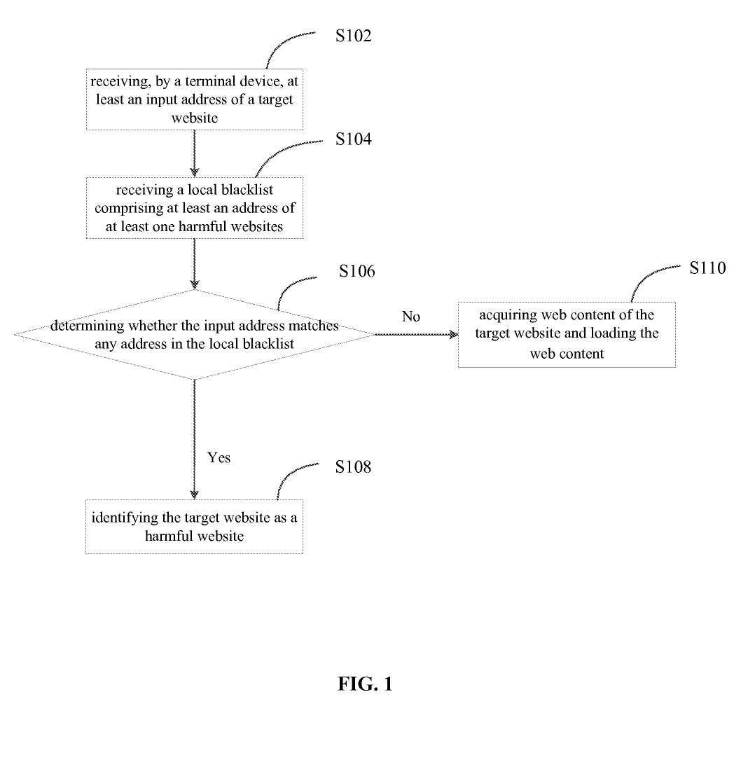

In one embodiment of a method for identifying harmful websites as shown in FIG. 1, the method can be implemented by a computer program, and the computer program may be run on mobile devices based on Von Neumann system, e.g. smart mobile phones, panel computers, notebook computers, palm-sized computers and electronic reading devices. The method comprises the following steps:

Step S102: receiving, by a terminal device, at least an input address of a target website.

In one embodiment, the method may be based on a browser, an example of the terminal device, through which an input website address is acquired. For example, a user may input a website address through the address field of a browser and may also input a website by clicking a link on a webpage in the browser. In some cases, the terminal device may refer to any appropriate user terminal with certain computing capabilities, such as a personal computer (PC), a work station computer, a server computer, a hand-held computing device (tablet), a smart phone or mobile phone, or any other user-side computing device. In various embodiments, the client may include a network access device. The client can be stationary or mobile.

Step S104: receiving a local blacklist comprising at least an address of at least one harmful website.

The local blacklist is configured to store harmful websites and may be a harmful website list stored on a mobile device, and the harmful website list records harmful websites. Harmful websites may be manually inputted by a user to the harmful website list.

In one embodiment, harmful websites may also be obtained by downloading from a security detection server, i.e. a harmful website database may be synchronized with the security detection server. The security detection server has a global blacklist stored thereon, and the security detection server may integrate numerous local blacklists uploaded by a plurality of mobile terminals into a global blacklist and distribute the global blacklist to the plurality of mobile terminals. A server, as used herein, may refer to one or more server computers configured to provide certain server functionalities, such as database management and search engines. A server may also include one or more processors to execute computer programs in parallel.

In this embodiment, the local blacklist periodically synchronizes with the security detection server and updates the harmful website list stored on the mobile terminals. In other embodiments, synchronization with the security detection server may be carried out after acquiring an input address of the target website.

Step S106: determining whether the input address of the target website matches any address in the local blacklist; if the target website matches any address of the harmful websites in the local blacklist, perform step S108: identifying the target website as a harmful website.

In this embodiment, if the target website does not match any address in the local blacklist, perform step S110: acquiring web content of the target website and loading the web content.

Addresses of harmful websites may be in the form of character strings, and character string matching may be performed to determine whether a target website matches any of the harmful websites in the harmful website database.

For example, determination of whether an inputted target website is a harmful website may be made by comparing the character string of the target website to that of any harmful website, comparing the character string of the domain name of the target website to that of any harmful website, or comparing the target website to the regular expression and asterisk wildcard of a harmful website.

In one embodiment, the method may further comprise the following steps after the step of “identifying the target website as a harmful website”: acquiring a security risk level of the target website; and prompting a warning message according to the security risk level of the target website.

In this embodiment, the security risk level of the target website may be correspondingly stored in the local blacklist, and security risk levels may include “credible” (i.e. safe), “suspicious” (i.e. risky) and “viral” (i.e. Trojan or virus exists), etc. Relevant warning message may be prompted to the user according to the security risk level.

Further, the method may further comprise the following step after the step of “acquiring a security risk level of the target website”: isolate the target website according to the security risk level.

For example, if the security risk level is “viral”, it indicates that the network resource corresponding to the target website has been determined to contain virus or Trojan files. Step may be taken to isolate the target website so as to rigorously prevent the virus or Trojan files corresponding to the target website from infecting local files through the network.

In one example embodiment, the step of “isolating the target website according to the security risk level” comprises: terminate connection with the target website according to the security risk level.

For example, when a user browses a forum if it is discovered that connection has already been established once the user logs in to that forum, the user may access and jump between pages by clicking post links on the forum page and as the dialogue does not expire during the jumping process, the browser and the forum always remain connected. When a certain post gets maliciously implanted with virus or Trojan posts by other user, websites linked or corresponding to the post are harmful websites and the security risk level is “viral”. Once the browser acquires the security risk level “viral” linked to the post, connection to the forum may be immediately terminated, thereby preventing the viruses or Trojans in the post from infecting the terminal on which the browser is located and achieving isolation.

In one embodiment, the method may further comprise the following steps after the step of “prompting a warning message according to the security risk level of the target website”: acquire an inputted “ignore warning” command; acquire relevant webpage content according to the target website and load the webpage content.

For example, if the acquired security risk level is “suspicious”, it indicates that whether the target website is dangerous cannot be determined, then the browser displays a selection window to show a security risk prompt, and acquires an “ignore warning” command inputted by the user by means of the “ignore” button on the selection window. In other words, for suspicious websites, the user may manually ignore warning messages and continue to access the target website.

In this embodiment, the step of “acquiring relevant webpage content according to the target website” may comprise: acquire connection with the target website, initiate an access request through the connection and acquire relevant returned webpage content.

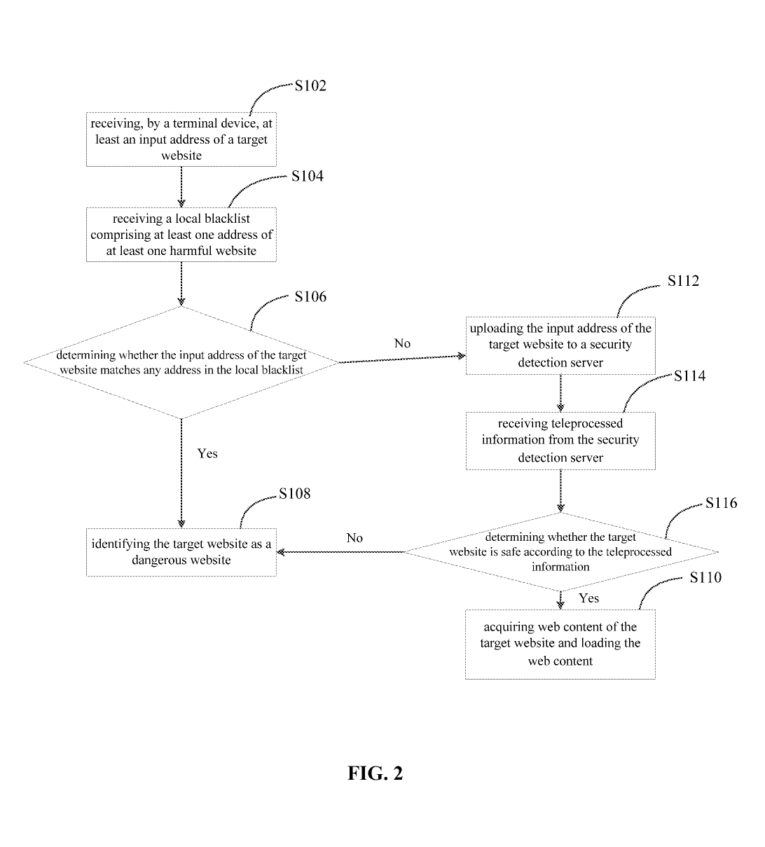

In one embodiment as shown in FIG. 2, the method may further comprise the following steps after the step of “judging whether the target website matches any of the harmful websites in the blacklist”:

if the target website does not match any of the harmful websites in the local blacklist, perform the following steps:

Step S112: uploading, by the terminal device, the input address of the target website to a security detection server.

Step S114: receiving teleprocessed information from the security detection server.

Step S116: determining whether the target website is safe according to the returned teleprocessed information; if the target website is not safe, perform step S108: identifying the target website as a harmful website. If the target website is safer, perform step S110: acquiring web content of the target website and loading the web content.

The security detection server may perform a security detection on the uploaded target website upon receiving requests from the terminal device and generates relevant detection results after detecting whether the uploaded website has any security risk. As mentioned above, the security detection server may comprise a global blacklist and the security detection server may perform a security detection by matching the uploaded target website with the global blacklist to determine whether the target website has any security risk. The matching method may be the aforesaid connection string matching, domain name matching, or regular expression matching.

The security detection server may further grab webpage content corresponding to the target website, perform virus scanning on the grabbed webpage content through virus database queries, and generate detection results according to the virus scanning results. In this context, a virus database may include programs, such as, for example, a destructive program that is disguised as a benign program (i.e. a Trojan Horse), a program that covertly performs an operation without the user's consent or knowledge (e.g. spyware), or other unfriendly programs. The detection results include the security risk level of the webpage content corresponding to the target website (i.e. the security risk level corresponding to the target website). Preferably, if the security detection server detects that the webpage content corresponding to the target website is risky, the security detection server may add the target website to the global blacklist.

In this embodiment, if the security risk level is “credible” or “suspicious”, the security detection server may add the grabbed webpage content to the returned teleprocessed information. The step of “acquiring corresponding webpage content according to the target website” may comprise: extracting webpage content corresponding to the target website from the teleprocessed information. Further, if the security risk level is “viral”, then the security detection server does not add webpage content corresponding to the target website to the returned teleprocessed information, so as to achieve isolation of the target website according to security risk level.

In another embodiment, the security detection server may not add the grabbed web content to the teleprocessed information, and the step of “acquiring corresponding webpage content according to the target website” may comprises: initiating data extraction request toward the security detection server, receiving webpage content corresponding to the target website and returning the webpage content by the security risk server. In other words, the browser need not directly access the target website and it accesses the target website indirectly through the security detection server.

In one embodiment, the method may further comprise the following step before the step of “receiving returned teleprocessed information”: creating connection corresponding to the target website. In other words, after transmitting the target website to the security detection server, the browser may establish connection with the target website without waiting for the teleprocessed information to be returned from the security detection server. If the security risk level of the target website included in the teleprocessed information returned by the security detection server is “credible”, then the terminal device, e.g. a browser, directly acquires the created connection with the target website and initiates a webpage access request toward the target website through the connection; if the security risk level of the target website included in the returned teleprocessed information is “viral”, the terminal device terminates the connection to prevent infection. Creating corresponding connection with the target website before the step of receiving the returned teleprocessed information may save waiting time, thereby increasing the response speed of the browser.

In an application scenario, after the user inputs a website to the browser address field the mobile terminal may first create connection corresponding to the inputted website and search the harmful website database stored on the mobile terminal for any harmful website matching the inputted website. If a harmful website is found, prompt security warning message; if otherwise, transmit the inputted website to the security detection server. The security detection server performs character string matching on the website (the security detection server may have a harmful website list stored thereon), or grabs the network resource corresponding to the website, performs security analysis on the network resource, generates detection results and returns the detection results to the mobile terminal. After the mobile terminals receives the detection results, prompt security warning message and terminate the established connection corresponding to the website if the detection results show that the website is insecure; or initiate an access request through the established connection corresponding to the website if the detection results show that the website is secure.

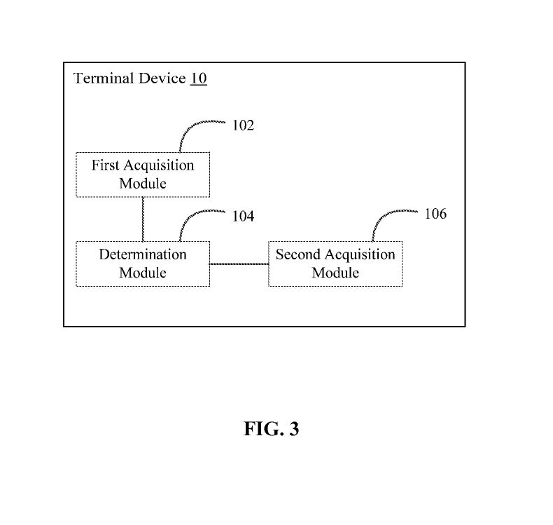

In one embodiment, a terminal device 10 for identifying harmful websites as shown in FIG. 3 comprises: a first acquisition module 102 configured to acquire at least an input address of a target website; a second acquisition module 106 configured to acquire a local blacklist, the local blacklist including at least one address of at least one harmful websites; a determination module 104 configured to determine whether the input address of the target website matches any address of the harmful websites in the local blacklist, and to identify the target website as a harmful website if the target website matches any of the harmful websites in the local blacklist.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

In one embodiment, the terminal device 10 for identifying harmful websites further comprises a warning prompt module 108 configured to acquire a security risk level of the target website and to prompt a warning message according to the security risk level of the target website.

In one embodiment, the terminal device 10 for identifying harmful websites further comprises an isolation module 110 configured to block the target website according to the security risk level.

In one embodiment, the isolation module 110 is further configured to terminate connection with the target website according to the security risk level.

In one embodiment, the terminal device 10 for identifying harmful websites further comprises a loading module 112 configured to acquire an inputted “ignore warning” command; to acquire relevant webpage content according to the target website and to load the relevant webpage content.

In one embodiment, the loading module 112 is further configured to acquire connection with the target website, to initiate an access request through the connection and to acquire relevant returned webpage content.

In one embodiment, the determination module 104 is further configured to upload the target website to a security detection server when the target website does not match any of the harmful websites in the local blacklist; receive returned teleprocessed information; determine whether the target website is safe according to the returned teleprocessed information, and identify the target website as a harmful website if the target website is not safe.

In one embodiment, the determination module 104 is further configured to acquire relevant webpage content according to the target website and load the relevant webpage content if the target website is safe, after determining whether the target website is safe according to the returned teleprocessed information.

In one embodiment, the determination module 104 is further configured to extract webpage content corresponding to the target website from the teleprocessed information.

In one embodiment, the harmful website determination module 104 is further configured to create connection corresponding to the target website before receiving returned teleprocessed information.

In one embodiment, the terminal device 10 for identifying harmful websites further comprises a synchronization module 114 configured to synchronize the local blacklist with the security detection server.

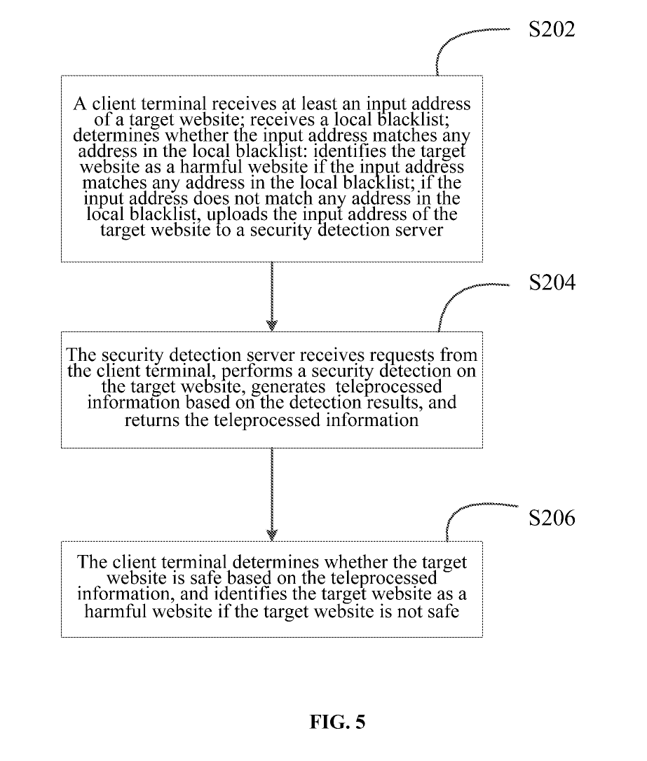

In one embodiment, a method for identifying harmful websites as shown in FIG. 5 comprises:

Step S202: a client terminal receives an input address of a target website; receives a local blacklist comprising at least one address of at least one harmful websites; determines whether the input address matches any address in the local blacklist: identifies the target website as a harmful website if the input address matches any address in the local blacklist, or uploads the target website to a security detection server if the input address of the target website does not match any address in the local blacklist;

Step S204: the security detection server performs a security detection on the target website, generates teleprocessed information based on the detection results, and returns the teleprocessed information;

Step S206: the client terminal determines whether the target website is safe according to the teleprocessed information, and identifies the target website as a harmful website if the target website is not safe.

In this embodiment, the method proceeds to acquire relevant webpage content according to the target website and load the relevant webpage content, if the client terminal determines the target website is safe according to the returned teleprocessed information.

In this embodiment, the step of “the security detection server performs a security detection on the target website” comprises that the security detection server acquires a global blacklist, and obtains detection results by determining whether the address of the target website matches any address in the global blacklist. Similarly, the matching methods may include a connection string matching, domain name matching or regular expression matching as described above.

The global blacklist may also include security risk levels of the harmful websites. The detection results may include the security risk level corresponding to the target website acquired from the global blacklist.

Further, the client terminal may also synchronize the local blacklist with the security detection server. A plurality of client terminals may share a security detection server and the security detection server may receive numerous local blacklists uploaded by the plurality of client terminals, integrate the local blacklists into the global blacklist stored thereon and distribute the integrated global blacklist to the plurality of client terminals. The client terminal may periodically synchronize the local blacklist with the security detection server, and may also synchronize the local blacklist with the security detection server when uploading the target website.

In this embodiment, the step of “the security detection server performs a security detection on the target website” further comprises the following steps.

The security detection server acquires a cached page corresponding to the target website from a webpage cache database, and performs a security detection by checking the cached page of the target website against a virus database and returns the detection results to the terminal device. The webpage cache database can be located within the security detection server, or alternatively the security detection server can acquire it from other server. Again in this context, a virus database may include programs, such as, for example, a destructive program that is disguised as a benign program (i.e. a Trojan Horse), a program that covertly performs an operation without the user's consent or knowledge (e.g. spyware), or other unfriendly programs.

The webpage cache database has the cached page corresponding to the target website stored therein, and the cached page is pre-grabbed webpage content corresponding to the target website.

In this embodiment, the security detection server may determine whether any cached page corresponding to the target website exists in the webpage cache database. If a cached page corresponding to the target website exists in the webpage cache database, the security detection server acquires the cached page. If no cached page corresponding to the target website exists in the webpage cache database, the security detection server acquires webpage content corresponding to the website and correspondingly stores the webpage content and the target website in the webpage cache database.

In this embodiment, the step of “the security detection server acquires webpage content corresponding to the target website” comprises: the security detection server initiates an access request toward the target website, and grabs relevant returned webpage content.

In other words, the security detection server may grab webpage content according to the target website, cache the grabbed webpage content in the webpage cache database, perform virus or Trojan scanning of cached pages in the webpage cache database by means of virus killing program or Trojan killing program on the security detection server, and generate detection results according to the scanning results. The detection results include security risk level corresponding to the target website.

It must be noted that the webpage access requests initiated by the security detection server when grabbing webpage content corresponding to the target website are all GET requests (requests using HTTP GET method), so as to prevent leakage of client information.

The method the method further comprises the following steps before the step of “the security detection server generates relevant teleprocessed information according to relevant detection results, and returns the relevant teleprocessed information”:

The security detection server acquires a security risk level of the target website according to the detection results, determines whether it is necessary to isolate the target website according to the security risk level, and adds the cached page corresponding to the target website to the teleprocessed information if it is not necessary to isolate the target website.

In this embodiment, the security detection server may isolate the target website when the security risk level is “viral” (i.e. it is determined that virus or Trojan exists in the webpage content corresponding to the target website), and the manner of isolation may be not to add the acquired cached page to the teleprocessed information, i.e. not to return the grabbed cached page to the client, thereby achieving isolation between the client and the target website.

In this embodiment, the method further comprises the following step after the step of “the client determines whether the target website is safe according to the teleprocessed information”:

Extract the cached page corresponding to the target website from the received teleprocessed information and load the cached page, if the target website is safe. In other words, the client need not establish connection with the target website, and by grabbing data twice from the target website the security detection server may be used directly to grab the webpage content when detecting the security risk of the target website, thereby increasing loading speed.

In this embodiment, the method further comprises the following step after the step of “the client determines the target website to be a harmful website”: the client extracts security risk level according to the teleprocessed information and prompts a warning message according to the extracted security risk level.

Further, the method further comprises the following step after the step of “the client prompts a warning message according to the extracted security risk level”: the client acquires an inputted “ignore warning” command, extracts the cached page corresponding to the target website from the received teleprocessed information, and loads the cached page.

In another embodiment, the security detection server is also connected to a transfer server and the step of “the security detection server acquires webpage content corresponding to the target website” comprises: the security detection server transmits the target website to a transfer server; the transfer server grabs webpage content corresponding to the target website, and returns the grabbed webpage content to the security detection server.

In other words, the security detection server merely serves the purpose of performing virus or Trojan detection on cached pages in the webpage cache database, and the transfer server grabs webpage content corresponding to the target website and returns it to the security detection server. The security detection server may be connected to a plurality of transfer servers and the plurality of transfer servers may asynchronously grab the webpage content, thereby increasing running speed.

In this embodiment, the method comprises the following steps before the step of “the transfer server returns the grabbed webpage content to the security detection server”: the client terminal uploads page parameters to the transfer server through the security detection server; the transfer server acquires the uploaded page parameters, and adjusts data format of the grabbed webpage content according to the page parameters.

In other words, the client terminal may upload relevant page parameters at the same time when it uploads the target website to the security detection server. When entrusting the transfer server to grab webpage content, the security detection server may upload the page parameters to the transfer server. Page parameters may include screen dimensions, resolution, equipment type, or operation system type of the client terminals. The transfer server may adjust data format of the grabbed webpage content according to the page parameters.

For example, if a user uses a mobile phone browser to go online, then the page parameters include screen dimensions and resolution of the mobile phone, and the transfer server adjusts the grabbed webpage content to a format suitable for browsing on a mobile phone. If a user uses a notebook computer to go online, then the transfer server adjusts the grabbed webpage content to a format suitable for browsing on a notebook computer.

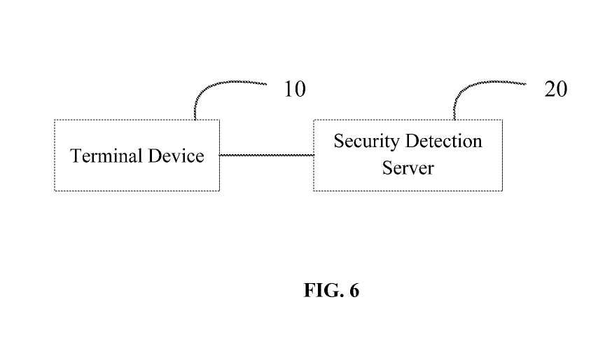

In one embodiment, a system for identifying harmful websites as shown in FIG. 6 comprises a client terminal device 10 and a security detection server 20, wherein: the terminal device 10 is configured to acquire an input address of a target website, acquire a local blacklist comprising at least an address of at least one harmful website, determine whether the input address of the target website matches any address of the harmful websites in the local blacklist; if the input address matches one address in the local blacklist, identify the target website as a harmful website; if the input address does not match any address in the local blacklist, upload the input address to the security detection server 20; receive teleprocessed information from the security detection server; determine whether the target website is safe based on the teleprocessed information; and identify the target website as a harmful website if the target website is not safe.

The security detection server 20 is configured to receive requests to perform a security detection on the target website, perform a security detection on the target website, generate teleprocessed information based on the detection results, and return the teleprocessed information to the terminal client. In one embodiment, the security detection server 20 is further configured to acquire a global blacklist, and to obtain detection results by performing character string matching on the target website and the harmful websites in the global blacklist.

In one embodiment, the security detection server 20 is further configured to acquire a webpage cache database, to acquire a cached page corresponding to the target website from the webpage cache database, and to obtain detection results by performing virus database queries or Trojan database queries against the cached page.

In one embodiment, the security detection server 20 is configured to acquire webpage content corresponding to the target website, and to correspondingly store the webpage content and the target website in the webpage cache database.

In one embodiment, the security detection server 20 is further configured to initiate an access request toward the target website, and to grab relevant returned webpage content.

In this embodiment, the client terminal device 10 is further configured to extract the cached page corresponding to the target website from the received teleprocessed information and to load the cached page, after the client terminal determines the target website to be safe according to the teleprocessed information.

In this embodiment, the client terminal device 10 is further configured to extract security risk level according to the teleprocessed information and to prompt a warning message according to the extracted security risk level.

In this embodiment, the client terminal 10 is further configured to acquire an inputted “ignore warning” command, to extract the cached page corresponding to the target website from the received teleprocessed information, and to load the cached page.

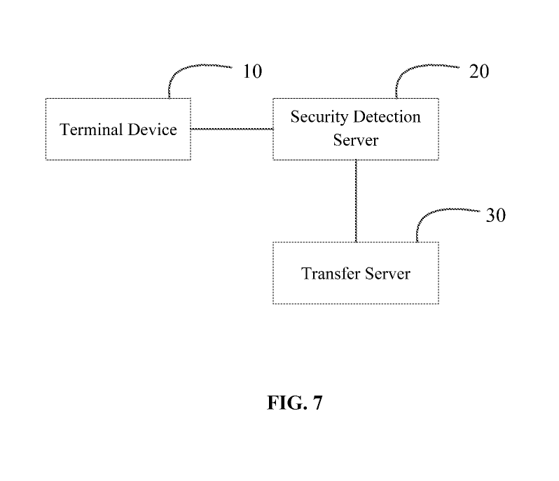

In another embodiment, a system for identifying harmful websites as shown in FIG. 7 further comprises a transfer server 30; wherein: the security detection server 20 is further configured to transmit the target website to the transfer server; the transfer server 30 is configured to receive the input address of the target website from the security detection server 20, acquire web content of the target website, and return the web content to the security detection server. In one embodiment, the client terminal device 10 is further configured to upload page parameters to the transfer server 30 through the security detection server 20; and the transfer server 30 is further configured to acquire the uploaded page parameters, and adjust data format of the webpage content according to the page parameters.

In one embodiment, the security detection server 20 is further configured to acquire a security risk level of the target website according to the detection results, to determine whether it is necessary to isolate the target website according to the security risk level, and to add the cached page corresponding to the target website to the teleprocessed information if it is not necessary to isolate the target website.

The foregoing methods, device and system for identifying harmful websites perform security detection at a client terminal to determine whether an inputted website is harmful, so that the client terminal does not have to totally rely on the harmful website identification functions of the gateways of the various subnets when the carrier switches between different subnets during movement, and thereby improves security.

The foregoing method and system for identifying harmful websites perform detection on an inputted website both at a client terminal locally and on a security detection server and further reduce the risk of omitting any harmful website, thereby improving security.

It should be appreciated that some of the processes of the foregoing embodiments may be completed by software and also hardware instructed by computer program which may be stored in a computer-readable storage medium, and the computer program may include the processes of those embodiments of the aforesaid methods. The storage medium may include a magnetic disk, a compact disk, a read-only memory (ROM), a random access memory (RAM), etc.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

1. A method for identifying harmful websites, comprising:
receiving, by a terminal device having a processor, at least one input address of a target website;
receiving, by the terminal device having a processor, a local blacklist comprising at least an address of at least one harmful website;
determining, by the terminal device having a processor, whether the input address of the target website matches any address in the local blacklist; and
if the input address of the target website match one address in the local blacklist, identifying the target website as a harmful website;
if the input address of the target website does not match any address in the local blacklist, uploading the input address to a security detection server.

2. The method according to claim 1, further comprising:
receiving teleprocessed information from the security detection server;
determining whether the target website is safe based on the teleprocessed information; and
if the target website is not safe, identifying the target website as a harmful website;
if the target website is safe, acquiring web content of the target website, and loading the web content.

3. The method according to claim 1, after identifying the target website as a harmful website, further comprising
acquiring a security risk level of the target website; and
prompting a warning message according to the security risk level of the target website.

4. The method according to claim 3, after prompting a warning message according to the security risk level of the target website, further comprising
receiving an input “ignore warning” command;
acquiring web content of the target website; and
loading the web content.

5. The method according to claim 1, further comprising:
synchronizing the local blacklist with the security detection server.

6. The method according to claim 1, further comprising:
uploading, by the terminal device, at least one page parameter to a transfer server through the security detection server.

7. A method for identifying harmful websites for terminal devices, comprising:
receiving, by a server device having a processor, a request to perform a security detection on a target website;
performing, by the server device, a security detection on the target website;
generating, by the server device, teleprocessed information based on the security detection results; and
returning, by the server device, the teleprocessed information to the terminal device.

8. The method of claim 7, wherein performing a security detection on the target website further comprises:
acquiring, by the server device, a global blacklist comprising at least an address of at least one harmful website; and
determining whether the address of the target website matches any address in the global blacklist.

9. The method of claim 7, wherein performing a security detection on the target website further comprises:
acquiring, by the server device, a cached page of the target website from a webpage cache database;
performing, by the server device, a security detection by checking the cached page of the target website against a virus database; and
returning the detection results to the terminal device.

10. The method of claim 9, wherein acquiring a cached page of the target website from the webpage cache database further comprises:
acquiring web content of the target website; and
updating the webpage cache database with the web content of the target website.

11. The method of claim 9, further comprising
transmitting the address of the target website to a transfer server; and
receiving, from the transfer server, web content of the target website.

12. The method of claim 11, further comprising:
acquiring, from the terminal device, at least one page parameter;
transmitting the page parameter to the transfer server; and
receiving, from the transfer server, adjusted web content based on the page parameter by the transfer server.

13. A device, comprising a processor and a non-transitory storage medium accessible to the processor, the non-transitory storage medium is configured to store the following modules implemented by the processor:
a first acquisition module configured to receive at least an input address of a target website;
a second acquisition module configured to receive a local blacklist comprising at least one address of at least one harmful website; and
a determination module configured to determine whether the input address matches any address in the local blacklist, if the input address matches one address in the local blacklist, identify the target website as a harmful website; and if the input address does not match any address in the local blacklist, uploading the input address to a security detection server; receiving teleprocessed information from the security detection server; determining whether the target website is safe based on the teleprocessed information, and if the target website is not safe, identifying the target website as a harmful website; if the target website is safe, acquiring web content of the target website, and loading the web content.

14. The device according to claim 13, further comprising a warning prompt module configured to acquire a security risk level of the target website and prompt a warning message according to the security risk level of the target website.

15. The device according to claim 13, further comprising an isolation module configured to block the target website based on the security risk level.

16. The device according to claim 14, further comprising a loading module configured to receive an inputted “ignore warning” command, acquire web content of the target website and load the web content.

17. The device according to claim 13, wherein the determination module is further configured to extract web content of the target website from the teleprocessed information.

18. The device according to claim 13, further comprising a synchronization module configured to synchronize the local blacklist with the security detection server.

19. A system for identifying harmful websites, comprising a client terminal and a security detection server, wherein:
the client terminal is configured to receive at least an input address of a target website, receive a local blacklist comprising at least an address of at least one harmful website, determine whether the address of the target website matches any address in the local blacklist;
if the input address matches one address in the local blacklist, identify the target website as a harmful website;
if the input address does not match any address in the local blacklist, upload the input address to the security detection server; receive teleprocessed information from the security detection server; determine whether the target website is safe based on the teleprocessed information; and identify the target website as a harmful website if the target website is not safe;
the security detection server is configured to receive requests to perform a security detection on the target website, perform a security detection on the target website, generate teleprocessed information based on the detection results, and return the teleprocessed information to the client terminal.

20. The system according to claim 19, further comprising a transfer server configured to:
receive the input address of the target website from the security detection server;
acquire web content of the target website; and
return the web content of the target website to the security detection server.
